(19) United States
(12) Patent Application Publication
(10) Pub. No.: US 2025/0335532 A1
(43) Pub. Date: Oct. 30, 2025

(54) CONTEXTUAL DYNAMIC CONTENT ADAPTATION ACCORDING TO USER ENGAGEMENT LEVEL

(71) Applicant: Capital One Services, LLC, McLean, VA (US)

(72) Inventor: Bryan TAMAYO, Allen, TX (US)

(21) Appl. No.: 18/648,056

(22) Filed: Apr. 26, 2024

(51) Int. Cl. G06F 16/958; H04L 67/1396

(52) U.S. Cl. CPC G06F 16/958; H04L 67/1396

(57) ABSTRACT

In some implementations, a system may obtain behavior information that indicates one or more user interactions with web content presented on a user device. The system may generate, using an artificial intelligence or machine learning model, one or more predictions associated with the web content based on the behavior information. In some implementations, the one or more predictions include a predicted intent associated with the one or more user interactions with the web content. The system may identify, based on the behavior information, a current user engagement level with the web content presented on the user device. The system may generate an adapted version of the web content based on the one or more predictions and the current user engagement level. The system may deliver the adapted version of the web content to the user device for presentation on the user device in accordance with the current user engagement level.

### BACKGROUND

A graphical user interface is a form of user interface that allows users to interact with electronic devices. A web browser may provide a graphical user interface that presents web pages. A user may navigate to a web page by entering a web address into an address bar of the web browser and/or by clicking a link that may be displayed in an application or another web page. Navigation to a web page may consume resources of a client device on which the web browser is installed, may consume resources of a web server that serves the web page to the client device, and may consume network resources used for communications between the client device and the web server. Furthermore, in cases where a web page includes interactive content (e.g., calculators, tools, surveys, or other content that takes user input and/or responds to user actions), actions that are performed with respect to the interactive content may consume additional resources of the client device, the web server, and/or the network.

### SUMMARY

Some implementations described herein relate to a system for contextual and dynamic web content adaptation. The system may include one or more memories and one or more processors communicatively coupled to the one or more memories. The one or more processors may be configured to obtain behavior information that indicates one or more user interactions with web content presented on a user device. The one or more processors may be configured to generate, using an artificial intelligence or machine learning model, one or more predictions associated with the web content based on the behavior information, wherein the one or more predictions include a predicted intent associated with the one or more user interactions with the web content. The one or more processors may be configured to identify, based on the behavior information, a current user engagement level with the web content presented on the user device. The one or more processors may be configured to generate an adapted version of the web content based on the one or more predictions and the current user engagement level. The one or more processors may be configured to deliver the adapted version of the web content to the user device for presentation on the user device in accordance with the current user engagement level.

Some implementations described herein relate to a method for contextual and dynamic web content adaptation. The method may include predicting, by a system, a user intent associated with behavior information that indicates one or more user interactions with web content presented on a user device. The method may include identifying, by the system, a current user engagement level with the web content presented on the user device based on the behavior information. The method may include generating, by the system, an adapted version of the web content based on the one or more predictions and the current user engagement level. The method may include delivering, by the system, the adapted version of the web content to the user device for presentation on the user device in accordance with the current user engagement level.

Some implementations described herein relate to a non-transitory computer-readable medium that stores a set of instructions. The set of instructions, when executed by one or more processors of a system, may cause the system to obtain behavior information that indicates one or more user interactions with web content presented on a user device. The set of instructions, when executed by one or more processors of the system, may cause the system to identify, based on the behavior information, a current user engagement level with the web content presented on the user device. The set of instructions, when executed by one or more processors of the system, may cause the system to generate an adapted version of the web content based on the current user engagement level. The set of instructions, when executed by one or more processors of the system, may cause the system to deliver the adapted version of the web content to the user device for presentation on the user device in accordance with the current user engagement level.

### BRIEF DESCRIPTION OF THE DRAWINGS

FIGS. 1A-1B are diagrams of an example associated with contextual dynamic content adaptation according to a user engagement level, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with contextual dynamic content adaptation according to a user engagement level, in accordance with some embodiments of the present disclosure.

FIG. 4 is a flowchart of an example process associated with contextual dynamic content adaptation according to a user engagement level, in accordance with some embodiments of the present disclosure.

### DETAILED DESCRIPTION

The following detailed description of example implementations refers to the accompanying drawings. The same reference numbers in different drawings may identify the same or similar elements.

In web design, user engagement relates to a degree to which visitors interact with and/or pay attention to a website. For example, user engagement may encompass actions such as reading content, commenting, sharing, liking, purchasing products, filling out forms, applying for services, or any other form of interaction with or attention to web content. User engagement is an important consideration in web design for several reasons, including improved user experience, increased conversion rates, higher retention rates, better search engine optimization performance, and/or improved website analytics. For example, when users find a website interesting, informative, or entertaining, users are more likely to spend time on the website, leading to increased satisfaction and loyalty. In addition, engaged users are more likely to convert or perform a call to action, which is a prompt that encourages users to perform a specified action (e.g., making a purchase, signing up for a newsletter, signing up for a free trial, sharing on social media, contacting support personnel, or the like). Furthermore, users that are engaged with a website and the associated content are more likely to return to the website and spend time on the website, which reduces bounce rates, increases overall retention, improves user engagement metrics that search engines consider when ranking websites, and/or provides valuable analytics related to user behavior and preferences (e.g., click-through rates, social shares, and/or comments, among other examples) that can help website developers to understand the content that resonates with users and make informed decisions about future improvements.

However, despite user engagement being an important factor for creating a positive user experience, driving conversions, building brand loyalty, and/or achieving long-term success, existing website designs often struggle to retain user attention, especially when users intend to leave a web page, cease to actively engage with the web page, and/or return to inactive or abandoned browser tabs. For example, a website may fail to retain user attention due to factors such as poor content quality that may not be engaging, informative, or relevant to user interests, slow load times that frustrate users and lead to higher bounce rates, complex or confusing navigation structures that interfere with users finding the content that they are interested in, distracting or disruptive advertisements or multimedia content, and/or a lack of personalized content or recommendations tailored to user interests and preferences, among other examples.

Accordingly, in some cases, web content may be designed to improve user engagement and/or re-engage users that are likely to exit or close a website, idle or inactive users, and users that return to a previously inactive browser tab. However, existing efforts to re-engage users with a website and/or prevent users from disengaging with a website suffer from various drawbacks. For example, in some cases, a website may include static calls to action that remain constant regardless of user behavior, which fail to adapt to a user intent or user engagement level and result in reduced effectiveness and conversion rates as users tend to increasingly ignore static calls to action over time. In another example, some websites heavily rely on pop-ups to capture user attention and drive conversions, but an overabundance of pop-ups can create a negative user experience that may lead to frustration and increased bounce rates. Furthermore, users often perceive excessive pop-ups as intrusive, which may drive users to leave the web page altogether. In other examples, efforts to retain or re-engage user attention may include static exit pop-ups that are triggered when a user attempts to leave a web page, which may interrupt a user's natural navigation flow and deter the user from leaving the web page on their own terms, time-triggered calls to action that appear after a certain period of user inactivity, which lacks personalization based on user behavior and intent and suffers from ineffectiveness due to marginal or no relevance to a current user browsing session, persistent banners or headers that feature calls to action that are visible throughout a user's interaction with a web page, which tend to be distracting and occupy valuable real estate on a display, and/or sticky navigation bars that feature calls to action that remain fixed at the top or bottom of the page as users scroll, which fail to consider reasons why a user may intend to exit a web page and/or their scroll behavior.

Some implementations described herein relate to techniques to provide contextual and dynamic content adaptation based on a user engagement level. For example, as described herein, some implementations described herein may dynamically adapt web content to increase a current user engagement level in accordance with user behavior information that may be used to predict a user intent associated with one or more user interactions with the web content. For example, in some implementations, content adaptation may be triggered when a user is about to exit or close a web page, when a user has a web page open but is not actively engaged with the web page, and/or when a user returns to a web page in a previously inactive browser tab, among other examples. In some implementations, the content adaptation may be responsive to user behavior information to re-engage a user at these and other critical junctures in order to retain user attention or steer the user toward performing a call to action. For example, in some implementations, the web content may be adapted to provide a streamlined view of the web content, such as a summary of the interactions that the user has performed, and/or to increase the visibility of a call to action, and the adapted web content may be presented to the user at a strategic time and in a focused manner to ensure that the adapted web content is aligned with a user intent. In this way, some implementations described herein may provide dynamic and personalized adapted web content to strategically engage users at a time when they may be about to exit a web page and/or return to a web page, by optimizing call to action placement based on user behavior, which may conserve resources that may otherwise be consumed if the user were to perform the same interactions on a return visit to the web page. Additionally, or alternatively, by assisting a user with completing a task that the user intended to perform when accessing a web page, some implementations described herein may increase conversion rates, improve user experience, and avoid wasting resources that may have been consumed by the user navigating and interacting with the website without completing the task that the user intended to perform.

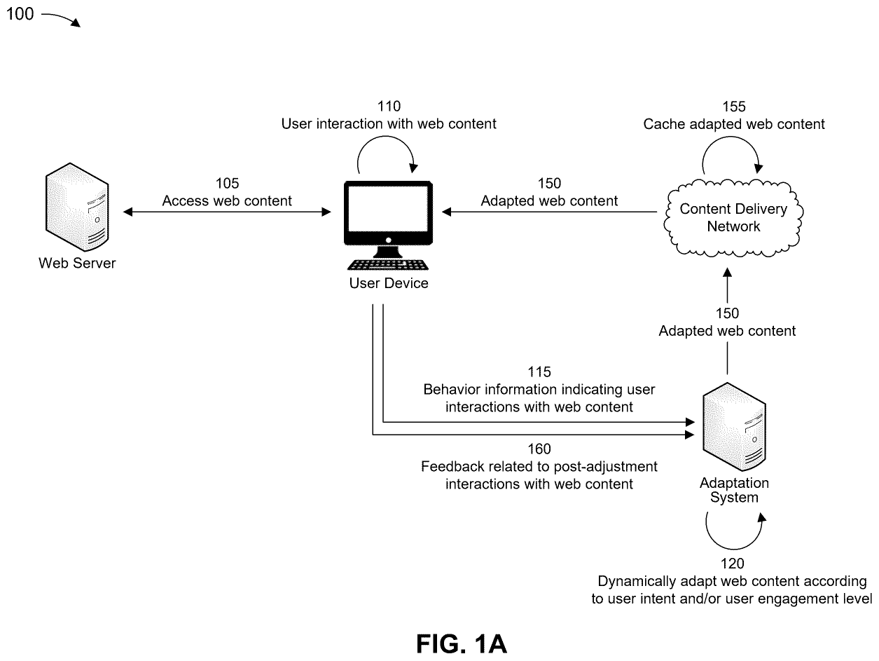

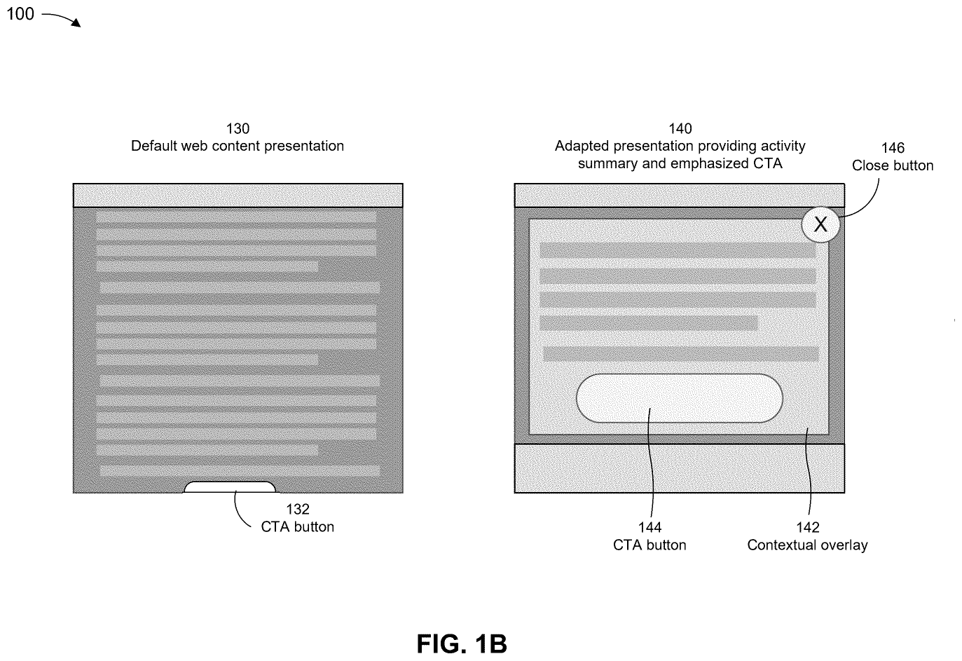

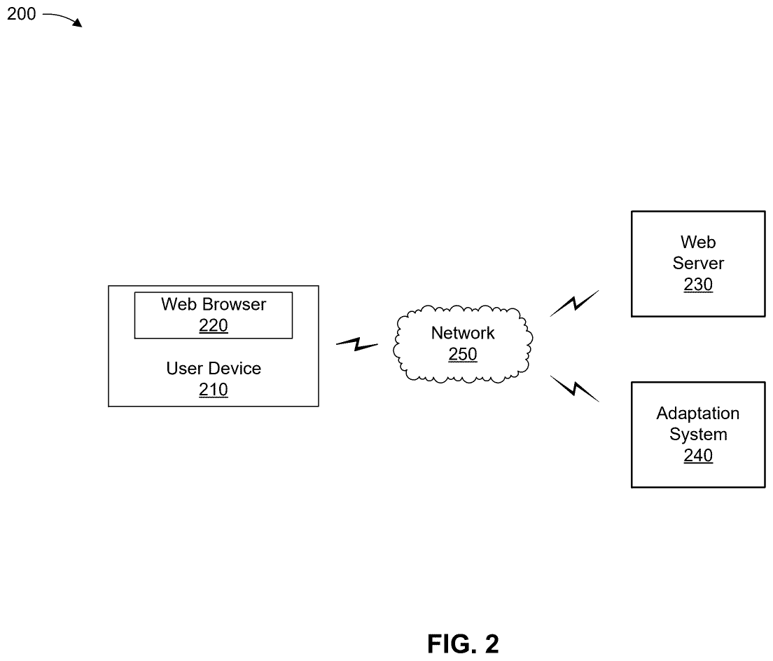

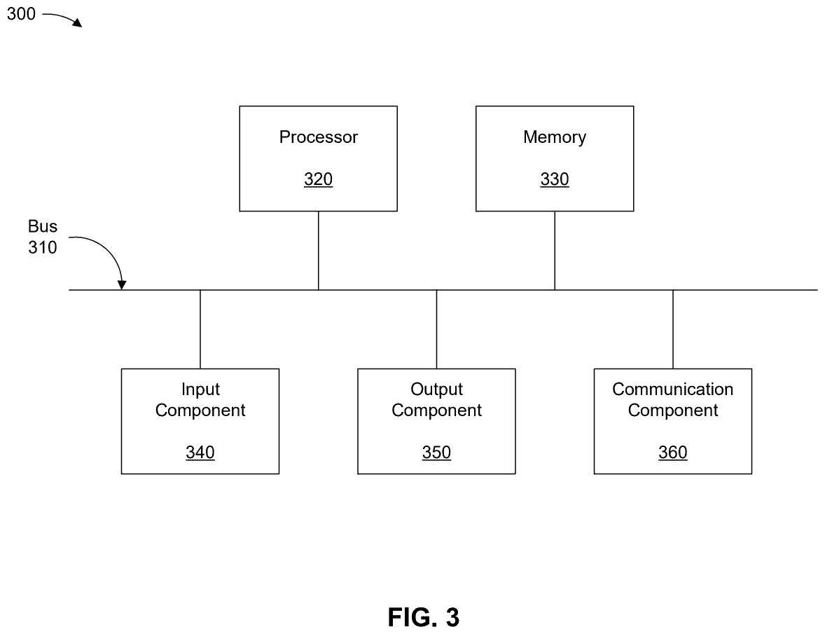

FIGS. 1A-1B are diagrams of an example 100 associated with contextual dynamic content adaptation according to a user engagement level. As shown in FIGS. 1A-1B, example 100 includes a user device, a web server, and an adaptation system. The user device, the web server, and the adaptation system are described in more detail in connection with FIGS. 2-3. As described herein, the user device may be associated with a user, and may implement a user interface (e.g., a graphical user interface), such as a web browser. For example, the user device may include a web browser application, which the user device may execute to load web pages.

As shown in FIG. 1A, and by reference number 105, the user device may communicate with the web server to access web content, such as a web page. For example, the user device may send, to the web server, a hypertext transfer protocol (HTTP) request or another suitable request that indicates a uniform resource identifier (URI), such as a uniform resource locator (URL) and/or a uniform resource name (URN), or another suitable identifier associated with the web content. For example, in some implementations, the user device may send the HTTP request based on a user input that enters the URI or other identifier into an address bar of a web browser and/or based on a user input selecting a link (e.g., within the web browser or another application) associated with the URI or other identifier of the web content. The user device may then receive the web content from the web server. As described herein, the web content may generally include any suitable content, such as text, images, multimedia (e.g., audio and/or video in one or more embedded video players), and/or interactive content (e.g., calculators, tools, search interfaces, games, and/or quizzes, among other examples). Furthermore, the web content may relate to a news article, a blog post, information for a product or a service, or the like.

In some implementations, the web content may include one or more calls to action, which generally relate to a prompt (e.g., in the form of a button, hyperlink, or the like) that directs the user toward performing a specific action. For example, a call to action may be phrased as a command or action (e.g., “Sign Up” or “Buy Now”), and is an important element in web content to direct the user about what action to perform next. Otherwise, without a clear call to action, there may be a risk that the user will not know the next steps to take to make a purchase, sign up for a newsletter, or the like, which may result in wasted resources if the user ends up leaving the website without accomplishing the task that the user intended to perform. For example, if a user reads a blog article and the web content does not contain a clear call to action, the reader may be likely to leave the website without completing any other tasks, such as signing up or subscribing to an email newsletter, whereas a clear and prominent call to action may encourage the user to continue interacting with the website. In general, as described herein, a call to action may include any suitable request that is presented to a user accessing the web content, and can therefore take various forms depending on a context of the web content. For example, web content corresponding to a blog may include a call to action to read more articles, sign-up for a newsletter, support a sponsor, and/or share on social media, whereas web content published by a business-to-business entity may include a call to action to get started with a product or service, sign up for a product or service, register for a free trial, and/or contact a sales department. In other examples, electronic commerce web content may include a call to action to add a product to a shopping cart, checkout, buy now, or add a product to a wish list, and vehicle lending web content may include a call to action to prequalify for vehicle financing or apply for a loan, among other examples. In each case, the call to action generally tells the user what action to take next in order to continue interacting with the website and progress toward conversion.

In some implementations, the web content that the user device accesses from the web server may include code (e.g., client-side code, such as JavaScript code) configured to execute asynchronously with loading of the web content. Moreover, the web content may be associated with a document object model (DOM) or other suitable data structure that provides a hierarchical organization for the web content, which may be indicative of a layout of the web content. The web content may be organized in one or more containers of the DOM (e.g., using “DIV” hypertext markup language (HTML) tags). In some implementations, each container may be associated with respective style settings (e.g., cascading style sheet (CSS) styles) that define a visual appearance of the web content. In some implementations, a container (e.g., one or more of the containers) may have an attribute indicating that the web content is adaptable (e.g., based on behavior information related to the user interacting with the web content, an intent of the user interacting with the web content, and/or a level of user engagement with the web content). Accordingly, the user device may process the web content received from the web server and render the web content for presentation in the user interface (e.g., the web browser). For example, the user device may render the web content in connection with an initial page load of the web content on the user device. To render the web content, the user device (e.g., using the user interface) may parse (e.g., interpret) HTML of the web content, construct the DOM based on the HTML, apply style settings (e.g., CSS styles) to elements in the DOM, execute code of the web content (e.g., which may modify the DOM or style settings), and/or display the web content in the user interface (e.g., based on the DOM, the style settings, and the executed code).

As further shown in FIG. 1A, and by reference number 110, the user device may monitor interaction between the user of the user device and the web content rendered, displayed, or otherwise presented on the user interface (e.g., with the web content loaded in the web browser). For example, in some implementations, the interactions with the web content may be monitored using executable tracking code (e.g., JavaScript code snippets) included in the web content, such as page tags or web beacons that are added to the web content and run in the web browser when the user browses or otherwise interacts with the web content. In some implementations, the code that monitors the user interactions with the web content may collect behavior information that indicates the user interactions with the web content, which may be sent to the adaptation system for further analysis, as described in more detail elsewhere herein. In addition to sending the behavior information to the adaptation system, the tracking code may set a first party cookie on the user device, which may store anonymous information such as whether the user accessed the web content before (e.g., whether the user is a new or returning visitor), a timestamp of the current visit, and/or a referrer site or campaign that directed the user to the web content (e.g., a search engine, a keyword, a banner, or an email, among other examples, in cases where the user arrived at the web content by selecting a link tagged with tracking parameters). In this way, the behavior information may serve as a basis for understanding an intent of the user interacting with the web content and predicting changes in an engagement level (e.g., a potential exit from the web content, a potential change in an active/inactive state, or the like).

Accordingly, as described herein, the tracking code associated with the web content may monitor interactions between the user and the web content to generate behavior information that indicates the user interactions with the web content. For example, in some implementations, the behavior information may include scrolling behavior (e.g., a scroll depth, such as how far the user has scrolled through the web content), inactivity behavior (e.g., user inactivity or browser tab inactivity), clicking behavior (e.g., where mouse clicks occur within the web content, mouse movements within the web content, how often mouse clicks occur, or the like), touch gesture behavior (e.g., where touch gestures such as tapping or swiping occur in the web content, how often the touch gestures occur, what types of touch gestures are used, or the like), text selection behavior (e.g., where text is selected, how often text is selected, or the like), and/or text input behavior (e.g., where text is input within the web content, how often text is input, or the like), and/or browser behavior (e.g., switches between different browser tabs, whether the user moved the web browser to the background, whether the user focuses away from the web content, whether the user navigates away from the browser or web content, such as by closing a tab, window, or web browser application, or navigating to a different screen or different web content, and/or whether the website hosting the web content or an application displaying the web content crashed). In some implementations, the tracking code may generally monitor the user interactions in a continuous manner while the web content is presented in the web browser.

As further shown in FIG. 1A, and by reference number 115, the user device may send the behavior information that indicates the user interactions with the web content to the adaptation system. In this way, the adaptation system may obtain the behavior information such that the behavior information can be processed or otherwise interpreted to predict a user intent associated with the interactions with the web content and/or identify a current user engagement level with the web content, as described herein. In some implementations, the behavior information that indicates the user interactions with the web content may be sent to the adaptation system using one or more network protocols and/or infrastructure to ensure that the behavior information is securely transferred from the user device to the adaptation system with minimal latency. In this way, sending the behavior information that indicates the user interactions with the web content to the adaptation system may enable the adaptation system to dynamically apply adjustments to the web content in real-time, enhancing a user experience.

As further shown in FIG. 1A, and by reference number 120, the adaptation system may dynamically adapt the web content presented on the user device according to a user intent and current user engagement level. For example, in some implementations, the adaptation system may use one or more artificial intelligence or machine learning models to process the behavior information provided by the user device in real-time and generate one or more predictions associated with the web content based on the behavior information. For example, in some implementations, the adaptation system may analyze patterns in the behavior information to predict an intent associated with the user interactions with the web content. In some implementations, the intent of the user interactions may be predicted to determine how to best adapt the web content to re-engage the user before the user exits the web content (e.g., before the user closes a browser tab, switches to a different browser tab, or navigates to a different website), to re-engage the user in cases where the web content remains open within the web browser but the user is inactive, idle, or otherwise not actively engaged with the web content, and/or to re-engage the user if and/or when the user returns to the web content at a later time. For example, in some implementations, the web content may be adapted to assist the user with picking up where they left off before the change in the engagement level in cases where the predicted intent indicates a potential interest in further interacting with the web content or completing a call to action. Additionally, or alternatively, the adaptation system may refrain from adapting web content to re-engage the user in cases where the predicted intent indicates disinterest in further interacting with the web content or completing a call to action to avoid intrusive or unwelcome content that is inconsistent with the user context.

For example, in a scenario where the behavior information indicates that the user has scrolled through web content on a blog or web content associated with a retailer or electronic commerce provider, the interactions may lack any clear context or other indication that the user has an interest or intent to further interact with the web content or perform a call to action. Accordingly, in such cases, the adaptation system may refrain from adapting the web content (e.g., providing a pop-up or other call to action prompt to sign up for a newsletter or redeem a coupon) because there may be insufficient interactions or other behavioral history to indicate to the adaptation system that the user had an intent to further interact with the web content or perform the call to action. In this way, the adaptation system may conserve resources that would otherwise have been consumed generating an adapted version of the web content and network resources that would otherwise have been consumed delivering the adapted version of the web content to the user device in cases where the user interactions and/or other behavior information does not indicate an interest or intent to further interact with the web content, perform a call to action, or the like. For example, if the adaptation system were to generate the adapted version of the web content and deliver the adapted version of the web content to the user device in order to retain or re-engage the attention of the user, there may be a high probability that the user will quickly dismiss or ignore the adapted version of the web content, which would be a waste of the resources used to generate and deliver the adapted version of the web content.

In a contrasting example, the web content may include one or more interfaces to browse information related to vehicles that are available to purchase, lease, or otherwise finance in addition to a call to action prompt that can be selected to apply for vehicle financing. In one example scenario, the behavior information may indicate that the user has performed interactions such as clicking through a carousel of images corresponding to different vehicles, selecting a particular image to view more information about a specific vehicle, scrolling through an accordion fold of warranty information, and using a calculator tool to model an annual percentage rate, a monthly payment, or other financing information. However, after performing these interactions, the user may switch to a different browser tab or enter an inactive state without closing the web content, without selecting the call to action prompt to apply for vehicle financing. In this scenario, where the behavior information indicates a potential intent or interest in applying for vehicle financing, the adaptation system may generate an adapted version of the web content that visually emphasizes the call to action prompt to apply for vehicle financing and may deliver the adapted version of the web content to the user device in order to retain or re-engage the attention of the user. In this way, the adapted version of the web content may provide actionable options in furtherance of the intent and/or interest of the user (e.g., conserving resources because the user does not have to perform the same interactions again at a later time).

Accordingly, in some implementations, the adaptation system may (e.g., using one or more artificial intelligence or machine learning algorithms) analyze the behavior information captured on the user device (e.g., by the tracking code) in real-time to generate one or more predictions associated with the web content. For example, in some implementations, the one or more predictions may include a predicted intent that is indicated by the behavior information, such as a goal that the user had when initially accessing the web content (e.g., to consume certain content or perform certain actions), a goal that may have developed while the user was interacting with the web content, and/or a probable interest in performing an incomplete call to action prompt that is included in the web content. In some implementations, the adaptation system may dynamically generate the adapted version of the web content in cases where the predicted intent indicates a probable intent or a probable interest in further interacting with the web content, interacting with other related or unrelated web content, and/or completing an incomplete call to action prompt, among other examples.

Additionally, or alternatively, the adaptation system may (e.g., using one or more artificial intelligence or machine learning algorithms) analyze the behavior information captured on the user device to generate predictions related to a current user engagement level with the web content and/or a predicted change in the current user engagement level with the web content. For example, in some implementations, the adaptation system may analyze patterns in the behavior information to predict that the user is about to close the web content or switch to a different browser tab or a different application (e.g., based on the user scrolling the web content to a threshold depth, such as 90%, indicating that all of the web content has been viewed). In another example, the adaptation system may analyze the behavior information to determine that the web content is still open on the user device but the user is inactive or has otherwise not interacted with the web content within a threshold time period. In another example, the adaptation system may analyze the behavior information to predict that the user may return to the web content at a later time (e.g., based on the user bookmarking the web content or otherwise engaging in behavior indicating an intent to return to the web content before closing or navigating away from the web content, and/or based on the user leaving the web content open in an inactive browser tab). Accordingly, in some implementations, the adaptation system may generate the adapted version of the web content based on a determination or a prediction that the current user engagement level has decreased or will decrease (e.g., based on a determination or a prediction that the user has become or will soon become inactive, and/or based on a determination or a prediction that the user has closed or will soon cease to interact the web content). Additionally, or alternatively, the adaptation system may generate the adapted version of the web content based on a determination or a prediction that the current user engagement level has increased or will increased (e.g., based on a determination or a prediction that the user has returned or will soon return to the web content after previously becoming inactive or closing the web content). Furthermore, in some implementations, the adaptation system may dynamically generate the adapted version of the web content only when one or more criteria are satisfied. For example, in some implementations, the adapted version of the web content may be generated only when the behavior information indicates or supports a determination or a prediction that the current user engagement level has changed or will change in addition to a determination or a prediction that the user has a probable intent or interest to perform certain actions associated with the web content (e.g., further interacting with the web content, accessing other web content, and/or completing an incomplete call to action prompt, among other examples).

In some implementations, in cases where the adaptation system makes a determination to generate the adapted version of the web content, the adaptation system may generates an adapted version of the web content that selectively streamlines the web content or certain content elements in accordance with various factors, such as the current or predicted user engagement level, the predicted intent or interest of the user, the position that the user has scrolled or browsed to within the web content, or the like. For example, in some implementations, the adapted version of the web content may include an interface with a set of content elements that selectively summarizes or recaps the interactions that the user has performed and/or visually emphasizes an incomplete call to action prompt by prominently displaying the call to action prompt in the field of view of the user and/or using features that are designed to retain or re-engage the attention of the user or otherwise assist the user in achieving the user intent that is indicated by the behavior information. Furthermore, in some implementations, the adapted version of the web content may be generated in accordance with the current or predicted user engagement level. For example, in some implementations, the adapted version of the web content may vary depending on whether the adaptation system determines or predicts that the user has closed or will cease interacting with the web content, that the user has or will have an inactive status within an active browser tab, or that the user has returned or will return to the web content from an inactive state.

For example, referring to FIG. 1B, reference number 130 corresponds to a default presentation of web content, without any dynamic adaptation that is based on the behavior of the user, the intent of the user, and/or the current engagement level of the user. In cases where the web content is bookmarked or kept open in an inactive browser tab, the user may not remember what interactions were previously performed or where the user had browsed or scrolled to within the web content after returning to the default presentation shown by reference number 130. For example, in many cases, users may leave web content open in an inactive browser tab for a lengthy time period, which may include days, weeks, months, or longer. Accordingly, the default presentation lacks any contextual information related to the user's previous engagement with the web content, which makes the user more likely to exit the web content. Furthermore, as shown by reference number 132, a call to action prompt may be partially visible (or entirely out of scroll view), which may result in the user being less likely to further interact with the web content or select the call to action prompt.

Accordingly, as further shown in FIG. 1B, reference number 140 corresponds to an adapted presentation of the web content, which may provide an activity summary and an emphasized call to action prompt to assist the user with achieving an intent associated with accessing or interacting with the web content. For example, reference number 140 corresponds to an adapted presentation of web content that may be generated based on a user returning to active status from an inactive status, based on the behavior information indicating that the user has scrolled the web content to a threshold depth, and/or based on the behavior information indicating that the user is about to close or cease interacting with the web content, among other examples. As shown by reference number 142, the adapted version of the web content may include a summary overlay with a set of content elements summarizing or recapping the interactions of the user (e.g., focusing on interactions that are relevant to the predicted intent, such as showing information related to a particular vehicle that the user spent significant time exploring within a vehicle shopping interface). As further shown by reference number 144, the adapted version of the web content may include an emphasized call to action prompt, which may be pulled into focus to be clear and centered in a field of view of the user. Additionally, or alternatively, the emphasized call to action prompt may include other design features to increase visibility or potential interest in the call to action prompt, such as the use of action words, contrasting colors, a visually appealing button shape, large and legible text, brief and concise text, first person speech, words or phrases that create a sense of urgency, using a color scheme that emphasizes the call to action prompt over other non-call to action prompts, words such as “free” that indicate a value proposition, visually appealing graphics, and/or a placement that follows a natural user flow (e.g., bottom right when the text is in a language such as English that is read top-down and left-to-right, or bottom left when the text is in a language such as Arabic that is read top-down and right-to-left), among other examples. In some implementations, as further shown by reference number 146, the adapted version of the web content may include an option to close the overlay or other adapted web content (e.g., if the user wants to return to browsing the web content after consuming the summary view and/or deciding to not perform the call to action at the current time).

Accordingly, in some implementations, the adapted version of the web content may generally include one or more content elements, one or more call to action prompts, and/or other suitable content to retain or re-engage the attention of the user and to service an intent and/or interest of the user. Furthermore, in some implementations, the adapted version of the web content may include one or more optimizations that are based on resource constraints and/or resource capabilities. For example, in some implementations, the adapted version of the web content may be generated using one or more algorithms that are configured to manage and/or optimize memory usage on the user device and/or one or more network devices that are used to generate, store, transmit, and/or otherwise process the adapted version of the web content. For example, the one or more memory algorithms may be configured to compress or otherwise reduce a data footprint of dynamic content adjustments to ensure that generating, storing, delivering, and/or rendering the adapted version of the web content does not adversely impact device performance or browser efficiency. Additionally, or alternatively, the adapted version of the web content may include one or more adaptive display optimizations, which may be used to adapt the rendering of the adapted version of the web content across diverse display technologies (e.g., providing different views for desktops, smartphones, and tablets). In this way, the adapted version of the web content may be optimized to be visually appealing and effective regardless of a type of the user device and/or to ensure that the strategic emphasis on call to action prompts or other dynamic web content is consistent and engaging across different platforms.

As further shown in FIG. 1A, and by reference number 150, the adaptation system may deliver the adapted version of the web content to the user device for presentation on the user device in accordance with the current user engagement level. For example, in some implementations, the adapted version of the web content may be delivered to the user device for presentation at a time when the current user engagement level has changed (e.g., decreased due to a transition to an inactive status or increased due to a return from inactive status to an active status) or is predicted to change (e.g., due to the behavior indicating that the user is likely to exit the web content). Furthermore, in some implementations, the time when the adapted web content is delivered to the user device and/or presented on the user device may be a current time (e.g., immediately to retain the user's attention) or at a future time (e.g., to re-engage the user's attention). Accordingly, in some cases, as shown by reference number 155, the adapted version of the web content may be cached at a node in a content delivery network that includes a set of geographically distributed servers, data centers, or other devices to speed up the delivery of web content by storing the web content in proximity to where the user device is located. In this way, using the content delivery network to cache and/or store the adapted version of the web content may ensure that the dynamically enhanced content generated by the adaptation system is delivered promptly (e.g., when the adapted web content is to be delivered to the user device at a future, such as when the behavior information satisfies one or more conditions), which may reduce load times, reduce latency, and/or improve an overall user experience.

As further shown in FIG. 1A, and by reference number 160, the adaptation system may receive, from the user device, feedback or other analytics related to behavior information and/or user interactions with the web content and/or the adapted version of the web content subsequent to the delivery and presentation of the adapted version of the web content on the user device. For example, in some implementations, the feedback or other analytics may be analyzed to determine how the user responded or reacted to the adapted version of the web content, the effectiveness of the adapted version of the web content, or the like. In this way, the feedback or other analytics may be used to refine one or more algorithms (e.g., artificial intelligence and/or machine learning algorithms) that the adaptation system used to determine or predict user intent, user interest, and/or a user engagement level, to generate and/or optimize adapted web content (e.g., where to place and/or how to visually format calls to action), and/or to ensure that the adapted web content is delivered and/or presented at a most impactful moment. In this way, the feedback or other analytics may be used to continuously improve the algorithms that are used to retain or re-engage user attention and/or improve conversion rates.

As indicated above, FIGS. 1A-1B are provided as an example. Other examples may differ from what is described with regard to FIGS. 1A-1B.

FIG. 2 is a diagram of an example environment 200 in which systems and/or methods described herein may be implemented. As shown in FIG. 2, environment 200 may include a user device 210 (e.g., which may execute a web browser 220), a web server 230, an adaptation system 240, and a network 250. Devices of environment 200 may interconnect via wired connections, wireless connections, or a combination of wired and wireless connections.

The user device 210 may include a device that supports web browsing. For example, the user device 210 may include a computer (e.g., a desktop computer, a laptop computer, a tablet computer, and/or a handheld computer), a mobile phone (e.g., a smart phone), a television (e.g., a smart television), an interactive display screen, and/or a similar type of device. The user device 210 may host a web browser 220 installed on and/or executing on the user device 210.

The web browser 220 may include an application, executing on the user device 210, that supports web browsing. For example, the web browser 220 may be used to access information on the World Wide Web, such as web pages, images, videos, and/or other web resources. The web browser 220 may access such web resources using a URI, such as a URL and/or a URN. The web browser 220 may enable the user device 210 to retrieve and present, for display, content of a web page. In some implementations, the user device 210 may execute one or more applications, such as a browser extension, that can extend or enhance functionality of the web browser 220. For example, in some implementations, the browser extension may be a plug-in application for the web browser 220. The browser extension may be capable of executing one or more scripts (e.g., code, which may be written in a scripting language, such as JavaScript) to perform an operation in association with the web browser 220 (e.g., monitoring behavior information that includes user interactions with web content presented in the web browser 220, analyzing the behavior information to identify a current user engagement level with the web content, and/or triggering adaptation of the web content based on a predicted intent of the user interactions, a predicted interest in a call to action prompt included in the web content, and/or the current user engagement level, among other examples).

The web server 230 may include a device capable of serving web content (e.g., web documents, HTML documents, web resources, images, style sheets, scripts, and/or text). For example, the web server 230 may include a server and/or computing resources of a server, which may be included in a data center and/or a cloud computing environment. The web server 230 may process incoming network requests (e.g., from the user device 210) using HTTP and/or another suitable protocol. The web server 230 may store, process, and/or deliver web pages to the user device 210. In some implementations, communication between the web server 230 and the user device 210 may take place using HTTP and/or another suitable protocol.

The adaptation system 240 may include one or more devices capable of receiving, generating, storing, processing, providing, and/or routing information associated with contextual dynamic content adaptation according to a user engagement level, as described elsewhere herein. The adaptation system 240 may include a communication device and/or a computing device. For example, the adaptation system 240 may include a server, such as an application server, a client server, a web server, a database server, a host server, a proxy server, a virtual server (e.g., executing on computing hardware), or a server in a cloud computing system. In some implementations, the adaptation system 240 may include computing hardware used in a cloud computing environment.

The network 250 may include one or more wired and/or wireless networks. For example, the network 250 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, a content delivery network, or the like, and/or a combination of these or other networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with contextual dynamic content adaptation according to a user engagement level. The device 300 may correspond to the user device 210, the web server 230, and/or the adaptation system 240. In some implementations, the user device 210, the web server 230, and/or the adaptation system 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

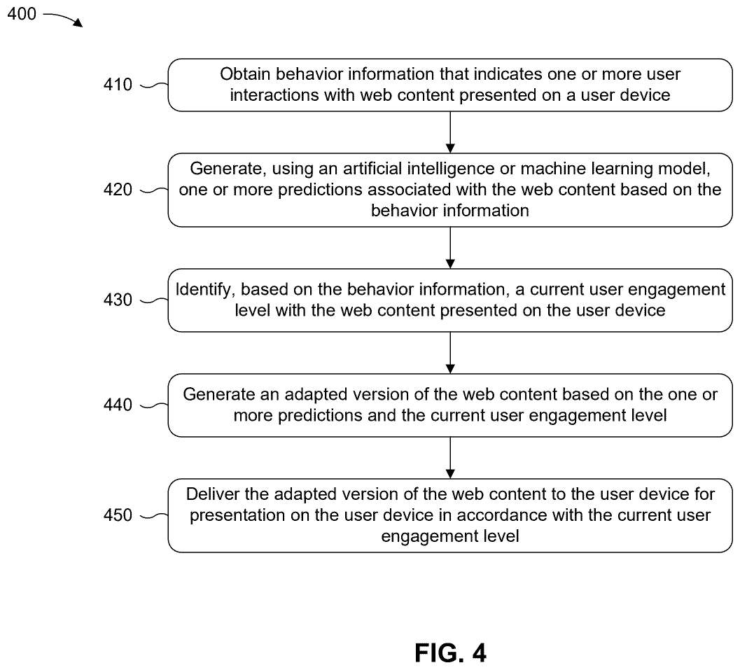

FIG. 4 is a flowchart of an example process 400 associated with contextual dynamic content adaptation according to a user engagement level. In some implementations, one or more process blocks of FIG. 4 may be performed by the adaptation system 240. In some implementations, one or more process blocks of FIG. 4 may be performed by another device or a group of devices separate from or including the adaptation system 240, such as the user device 210 and/or the web server 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining behavior information that indicates one or more user interactions with web content presented on a user device (block 410). For example, the adaptation system 240 (e.g., using processor 320 and/or memory 330) may obtain behavior information that indicates one or more user interactions with web content presented on a user device, as described above in connection with reference number 110 and/or reference number 115 of FIG. 1A. As an example, the web content may be a web page or other content associated with shopping for new or used vehicles, and the behavior information may include interactions such as mouse movements, mouse hovers, keyboard inputs, scrolling, or the like that are performed to view different vehicles, read reviews or warranty information associated with a particular vehicle, search for dealerships where the particular vehicle is available to be purchased or leased, and/or use a calculator tool to model a monthly payment based on an amount financed and an interest rate.

As further shown in FIG. 4, process 400 may include generating, using an artificial intelligence or machine learning model, one or more predictions associated with the web content based on the behavior information (block 420). For example, the adaptation system 240 (e.g., using processor 320 and/or memory 330) may generate, using an artificial intelligence or machine learning model, one or more predictions associated with the web content based on the behavior information, as described above in connection with reference number 110 and/or reference number 115 of FIG. 1A. As an example, the one or more predictions may include a predicted intent associated with the one or more user interactions with the web content. As an example, the predicted intent may be an intent to prequalify or apply for vehicle financing based on behavior information including interactions such as viewing different vehicles, reading vehicle reviews or warranty information, searching vehicle dealerships, and/or using calculator tools to model monthly payments.

As further shown in FIG. 4, process 400 may include identifying, based on the behavior information, a current user engagement level with the web content presented on the user device (block 430). For example, the adaptation system 240 (e.g., using processor 320 and/or memory 330) may identify, based on the behavior information, a current user engagement level with the web content presented on the user device, as described above in connection with reference number 115 and/or reference number 120 of FIG. 1A. As an example, the behavior information may indicate that the user has closed will close the web content, that the user has entered or will enter an inactive state, and/or that the user has returned or will return to the web content after a period of inactivity.

As further shown in FIG. 4, process 400 may include generating an adapted version of the web content based on the one or more predictions and the current user engagement level (block 440). For example, the adaptation system 240 (e.g., using processor 320 and/or memory 330) may generate an adapted version of the web content based on the one or more predictions and the current user engagement level, as described above in connection with reference number 120 of FIG. 1A and reference numbers 140, 142, 144, and 146 of FIG. 1B. As an example, where the predicted intent is an intent to prequalify or apply for vehicle financing and the current user engagement level is a return to the web content related to shopping for and/or financing vehicles, the adapted version of the web content may include a summary of the vehicles for which the user viewed additional details, modeled a loan, or the like and/or a call to action prompt that includes an option to submit a request to prequalify or apply for vehicle financing.

As further shown in FIG. 4, process 400 may include delivering the adapted version of the web content to the user device for presentation on the user device in accordance with the current user engagement level (block 450). For example, the adaptation system 240 (e.g., using processor 320 and/or memory 330) may deliver the adapted version of the web content to the user device for presentation on the user device in accordance with the current user engagement level, as described above in connection with reference number 150 and/or reference number 155 of FIG. 1A. As an example, the adapted version of the web content may be cached at a node in a content delivery network or provided to the user device such that the adapted version of the web content is presented on the user device at an appropriate time to retain or re-engage the attention of the user (e.g., based on the current user engagement level indicating that the user has returned to the web content related to shopping for and/or financing vehicles).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for contextual and dynamic web content adaptation, the system comprising:
one or more memories; and
one or more processors, communicatively coupled to the one or more memories, configured to:
obtain behavior information that indicates one or more user interactions with web content presented on a user device;
generate, using an artificial intelligence or machine learning model, one or more predictions associated with the web content based on the behavior information,
wherein the one or more predictions include a predicted intent associated with the one or more user interactions with the web content;
identify, based on the behavior information, a current user engagement level with the web content presented on the user device;
generate an adapted version of the web content based on the one or more predictions and the current user engagement level; and
deliver the adapted version of the web content to the user device for presentation on the user device in accordance with the current user engagement level.

2. The system of claim 1, wherein the adapted version of the web content includes a visual emphasis on an incomplete call to action prompt based on the predicted intent indicating a probable user interest in the incomplete call to action prompt.

3. The system of claim 1, wherein the adapted version of the web content includes a set of content elements summarizing the one or more user interactions with the web content.

4. The system of claim 1, wherein the adapted version of the web content is generated and delivered to the user device for presentation on the user device at a time when the current user engagement level indicates that all of the web content has been viewed.

5. The system of claim 1, wherein the adapted version of the web content is generated and delivered to the user device for presentation on the user device at a time when the current user engagement level indicates that a user is likely to close or cease interacting with the web content.

6. The system of claim 1, wherein the adapted version of the web content is generated and delivered to the user device for presentation on the user device at a time when the current user engagement level indicates an inactive status within an active browser tab.

7. The system of claim 1, wherein the adapted version of the web content is generated and delivered to the user device for presentation on the user device at a time when the current user engagement level indicates a return to an active status within a previously inactive browser tab.

8. The system of claim 1, wherein the adapted version of the web content has a data footprint that is based on one or more memory constraints.

9. The system of claim 1, wherein the adapted version of the web content is associated with one or more rendering parameters based on a display technology associated with the user device.

10. The system of claim 1, wherein the adapted version of the web content is delivered to the user device via a content delivery network that caches the adapted version of the web content at a first location in proximity to a second location of the user device.

11. The system of claim 1, wherein the one or more processors are further configured to:
obtain feedback related to one or more post-adaptation user interactions with one or more of the web content or the adapted version of the web content; and
refine one or more algorithms used to generate the one or more predictions, identify the current user engagement level, or generate the adapted version of the web content in accordance with the feedback related to one or more post-adaptation user interactions.

12. A method for contextual and dynamic web content adaptation, comprising:
predicting, by a system, a user intent associated with behavior information that indicates one or more user interactions with web content presented on a user device;
identifying, by the system, a current user engagement level with the web content presented on the user device based on the behavior information;
generating, by the system, an adapted version of the web content based on the one or more predictions and the current user engagement level; and
delivering, by the system, the adapted version of the web content to the user device for presentation on the user device in accordance with the current user engagement level.

13. The method of claim 12, wherein the adapted version of the web content includes one or more of a set of content elements summarizing the one or more user interactions with the web content or a visual emphasis on an incomplete call to action prompt.

14. The method of claim 12, wherein the adapted version of the web content is generated and delivered to the user device for presentation on the user device at a time when the current user engagement level indicates that all of the web content has been viewed.

15. The method of claim 12, wherein the adapted version of the web content is generated and delivered to the user device for presentation on the user device at a time when the current user engagement level indicates that a user is likely to close or cease interacting with the web content.

16. The method of claim 12, wherein the adapted version of the web content is generated and delivered to the user device for presentation on the user device at a time when the current user engagement level indicates an inactive status within an active browser tab.

17. The method of claim 12, wherein the adapted version of the web content is generated and delivered to the user device for presentation on the user device at a time when the current user engagement level indicates a return to an active status within a previously inactive browser tab.

18. A non-transitory computer-readable medium storing a set of instructions, the set of instructions comprising:
one or more instructions that, when executed by one or more processors of a system, cause the system to:
obtain behavior information that indicates one or more user interactions with web content presented on a user device;
identify, based on the behavior information, a current user engagement level with the web content presented on the user device;
generate an adapted version of the web content based on the current user engagement level; and
deliver the adapted version of the web content to the user device for presentation on the user device in accordance with the current user engagement level.

19. The non-transitory computer-readable medium of claim 18, wherein the adapted version of the web content includes a visual emphasis on an incomplete call to action prompt.

20. The non-transitory computer-readable medium of claim 18, wherein the adapted version of the web content includes a set of content elements summarizing the one or more user interactions with the web content.
